(19) United States
(12) Patent Application Publication
(10) Pub. No.: US 2006/0025159 A1
(43) Pub. Date: Feb. 2, 2006

(54) System and method for context-based notification of a received transmission

(75) Inventors: Leonardo William Estevez, Rowlett, TX (US); Carl M. Panasik, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/903,758

(22) Filed: Jul. 30, 2004

(51) Int. Cl. H04M 3/42

(52) U.S. Cl. 455/456.3; 455/415

(57) ABSTRACT

A system and method for context-based notification of a received transmission. Some illustrative embodiments may be an electronic communication system comprising a radio frequency (RF) receiver, location logic, a central processing unit (CPU), a notification device, and notification software. The RF receiver is adapted to receiver RF transmissions, the location logic is adapted to determine a current location of the electronic communication system, and the notification device is adapted to signal a user that a transmission has been received. The notification software executes on the CPU and causes the CPU to determine whether to activate the notification devices based on the current location of the mobile electronic communication system.

### BACKGROUND

1. Technical Field

The present subject matter relates to automatically selecting a mechanism for signaling receipt of an incoming communication to a user of a mobile electronic communication device. More particularly, the subject matter relates to selecting the signaling mechanism, if any, based on the user's current location, the user's scheduled activity, and the identity of the sender of the incoming communication.

2. Background

Mobile electronic devices have increased both in popularity and functionality in recent years. The ability to send and receive information in almost any form imaginable provided by such devices has resulted in a generation that goes nowhere without keeping at least one such device, if not more, within reach at all times. The ring tones of a cellular telephone have become an all to familiar sound in many public places today. Although many people are polite enough to either turn off their mobile electronic devices (e.g., a cellular telephone) or to set the notification method of the device to a silent mode, many others simply forget to do so. The large variety of locations that people visit over the course of an average day make it very difficult to remember to turn off or change the notification setting of a mobile electronic device depending on the location, time of day, and event or activities in progress at that location.

### SUMMARY OF THE PREFERRED EMBODIMENTS

The problems noted above are addressed in large part by a system and method for context-based notification of a received transmission. In at least one embodiment, the electronic communication system comprises a radio frequency (RF) receiver, location logic, a central processing unit (CPU), a notification device, and notification software. The RF receiver is adapted to receiver RF transmissions, the location logic is adapted to determine a current location of the electronic communication system, and the notification device is adapted to signal a user that a transmission has been received. The notification software executes on the CPU and causes the CPU to determine whether to activate the notification device based on the current location of the mobile electronic communication system.

In another embodiment, the electronic communication system comprises an RF receiver, a real-time clock, a storage device, a CPU, a notification device, and notification software. The RF receiver is adapted to receiver RF transmissions, the real-time clock is adapted to provide the CPU with a current time and date, the storage device is adapted to store a calendar of events, and the notification device is adapted to signal a user that a transmission has been received. The notification software executes on the CPU and causes the CPU to determine whether to activate the notification device based on the calendar of events and on the current time and date.

In still another embodiment, a method suitable for use in an electronic communication system comprises receiving a transmission, determining a current location of the electronic communication system, matching the current location with entries in a list of location-based constraints, and determining whether to activate a notification device of the communication system based on the matched constraints. In still another embodiment, a method suitable for use in an electronic communication system comprises receiving a transmission, determining a time and date, matching the current time and date with entries in a list of event-based constraints, and determining whether to activate a notification device of the communication system based on the matched constraints.

### BRIEF DESCRIPTION OF THE DRAWINGS

For a detailed description of the preferred embodiments of the invention, reference will now be made to the accompanying drawings in which:

FIG. 1 illustrates a block diagram of an electronic communication system constructed in accordance with at least some embodiments;

FIG. 2 illustrates a detailed block diagram of an electronic communication system constructed in accordance with at least some embodiments; and

FIG. 3 illustrates a preferred method for determining a context and selecting a notification type, in accordance with at least some embodiments.

### NOTATION AND NOMENCLATURE

Certain terms are used throughout the following discussion and claims to refer to particular system components. This document does not intend to distinguish between components that differ in name but not function.

In the following discussion and in the claims, the terms “including” and “comprising” are used in an open-ended fashion, and thus should be interpreted to mean “including but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

The term “software” includes any executable code capable of running on a CPU, regardless of the media used to store the software. Thus, code stored in non-volatile memory, and sometimes referred to as “embedded firmware,” is included within the definition of software. Also, the term “dataset” broadly means any logical grouping of data and does not imply any specific structure or type of data.

### DETAILED DESCRIPTION OF THE PREFERRED EMBODIMENTS

The following is a description of the preferred embodiments of the invention in the context of a mobile electronic communication system. However, it should be noted that the principles described herein are not limited to just mobile electronic communication system technology. In general, the apparatus and methods described herein can be applied to numerous other types of consumer electronic and computer devices.

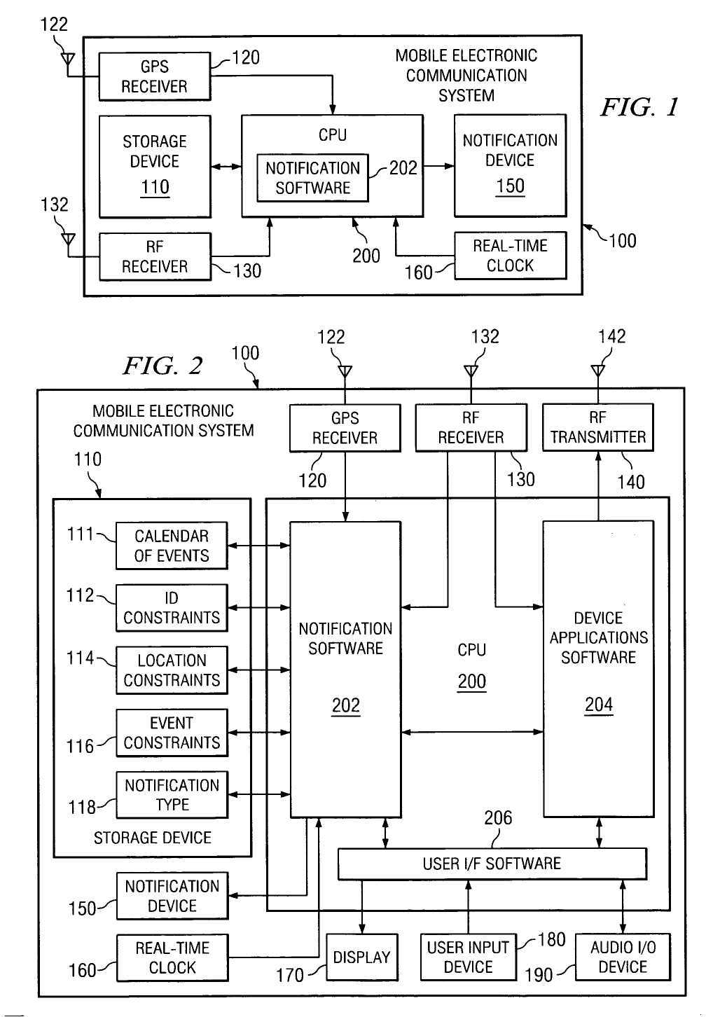

Referring now to FIG. 1, a mobile electronic communication system 100 constructed in accordance with at least some embodiments generally is adapted to automatically adjust the notification mechanism used to advise a user that a transmission has been received. The mobile electronic communication system 100 may comprise a storage device 110, a global positioning system (GPS) receiver 120, a GPS antenna 122, a radio frequency (RF) receiver 130, an RF receiver antenna 132, a notification device 150, a real-time clock 160, and a central processing unit (CPU) 200. The GPS antenna 122 couples to the GPS receiver 120, and likewise the RF receiver antenna 132 couples to the RF receiver 130. Both the GPS receiver 120 and the RF receiver couple to the CPU 200. The CPU 200 also couples to the storage device 110, the notification device 150 and the real-time clock 160. Notification software 202 executes on the CPU 200.

The RF receiver 130 of the preferred embodiment receives transmissions addressed to the mobile electronic communication system 100 via the RF receiver antenna 132. The transmission may be in the form of voice communications (e.g., calls on a cellular telephone), or other, text-based communications (e.g., e-mail, short message service (SMS) messages, and instant messaging (IM) messages). Notification software 202 executing on the CPU 200 processes the received transmission from which originator information is extracted. The GPS receiver 120 provides data indicative of the location of the mobile electronic communication system 100. The GPS receiver 120 can be replaced with any other type of location unit, logic or system. The notification software 202 also processes transmissions received by the GPS receiver 120 (via GPS antenna 122) and extracts information describing the current location of the mobile electronic communication system 100.

The notification software 202 combines the GPS-based location information, the current time and date provided by real-time clock 160, event information stored in a calendar of events on the storage device 110, and extracted originator information to determine the current location and activity of the user, and the identity of the originator of the incoming transmission. The notification software 202 of the preferred embodiment then determines what notification constraints, if any, may apply. Based on whether or not a constraint is found to apply, the notification software 202 may select one of a plurality of notification types, and may configure and enable the notification device 150 accordingly.

The notification device 150 may comprise several different mechanisms for signaling a user, such as a speaker, piezoelectric device, light bulb, light-emitting diode, and a vibrator. These mechanisms may be capable of generating different types of notifications, including one of several selectable ring tones, vibrations, or flashing visual indications. In addition to causing the selection of one of these notification types, an applicable constraint may cause the notification software 202 to not notify the user at all. Instead, the notification software 202 may save the contents of the transmission (e.g., by saving e-mail on the storage device 110) or forward the transmission to another destination for later review (e.g., by forwarding a cellular telephone call to an external voicemail system).

For example, assume the current time indicates that it is a Sunday afternoon at 1:30 P.M., and that the user's calendar of events dataset 111 indicates that he is in church from 1:00 to 2:00 P.M. on Sundays. The GPS receiver 120 reports a current location that is the location of the church and the originator information indicates a cellular telephone call from the user's mother. One of the notification constraints specifies that the user should be silently notified of an incoming transmission while he is in church only if the originator is his mother. Otherwise the user is not to be notified and the call is to be forwarded to voicemail. Under the above-listed conditions, the notification software 202 of the preferred embodiment would activate the vibration notification mode of the notification device 150 when the RF receiver 130 receives the incoming transmission.

FIG. 2 provides a detailed illustration of the mobile electronic communication system 100 constructed in accordance with at least some embodiments. In addition to the elements already described, the mobile electronic communication system 100 also may comprise an RF transmitter 140, a transmitter antenna 142, a display 170, a user input device 180 and audio input and output (I/O) device 190. The RF transmitter 140 and transmitter antenna 142 allow the mobile electronic communication system 100 to send transmissions and thus may provide the capability for full duplex communications. The display 170 may provide status information for the mobile electronic communication system 100, as well as feedback in response to actions taken by a user operating the user input device 180. The audio I/O device 190 may allow the mobile electronic communications device to provide voice communications, such as that provided by a cellular telephone. Additionally, the storage device 110 may comprise individual datasets including calendar of events dataset 111, identification (ID) constraints dataset 112, location constraints dataset 114, event constraints dataset 116, and notification type dataset 118. Also, like the notification software 202, device application software 204 and user interface (I/F) software 206 may execute on the CPU 200.

As illustrated, an arrow between two modules (hardware or software), or between a module and a dataset, denotes access or data flow between the respective modules and datasets. Thus, notification software 202, in accordance with at least some preferred embodiments, may send and receiver data from any of the datasets included within the storage device 110, receive data from the GPS receiver 120, the RF receiver 130, and the real-time clock 160, operate the notification device 150, and exchange data with the device applications software 204 and the user I/F software 206. The device application software 204 comprises such functionality as basic communications management (e.g., making a telephone call in response to a user request to dial on a cellular telephone), and the user I/F software 206 comprises functions that involve interaction with the user (e.g., accepting user input from user input device 180 and echoing the corresponding numbers on display 170).

The notification software 202 comprises functions that involve combining information gathered from elements within the mobile electronic communication system 100 and deciding whether and how to activate the notification device 150 based on the gathered information. RF receiver 130, via RF receiver antenna 132, receives an incoming transmission, and the notification software 202 begins to process the received data by extracting the originator ID information from the incoming transmission. The notification software 202 similarly determines the current location of the mobile electronic communication system 100 by processing GPS transmissions received by the GPS receiver 120 via the GPS antenna 122. The notification software 202 then retrieves the current time and date from real-time clock 160 and uses it to identify a corresponding event that may be stored in the calendar of events dataset 111. These three elements, the originator ID, the current location, and the current event, represent the information needed by the notification software 202 to determine what constraints, if any, may apply to the incoming transmission.

In accordance with at least some preferred embodiments, the constraints that may apply to the incoming transmission may be stored in a series of datasets maintained on storage device 110. Each datasets corresponds to constraints applicable to the each of the three elements listed above (ID, location, event). Thus, the ID constraints dataset 112 stores constraints applicable to a particular originator ID extracted from a received transmission. Likewise, the location constraints dataset 114 stores constraints applicable to a particular physical location (based, for example, on GPS coordinates), and the event constraints dataset 116 stores constraints applicable to a particular event, where the event may be identified, for example, by correlating the current time and date to stored events in the calendar of events dataset 111.

Once the applicable constraints, if any, have been identified, the notification software 202 may select a notification type. If no applicable constraint is identified a default notification type may be selected. The available types may be stored in the notification type dataset 118, and may include ring tone patterns, vibration patterns, not notifying the user at all, and other message-specific actions. One example of a message-specific action may be forwarding a cellular telephone call to an external voicemail system. Another example may be saving an e-mail message to an inbox and sorting the inbox e-mails such that event specific e-mails are listed first when the time and date of an event is near or an event is in progress.

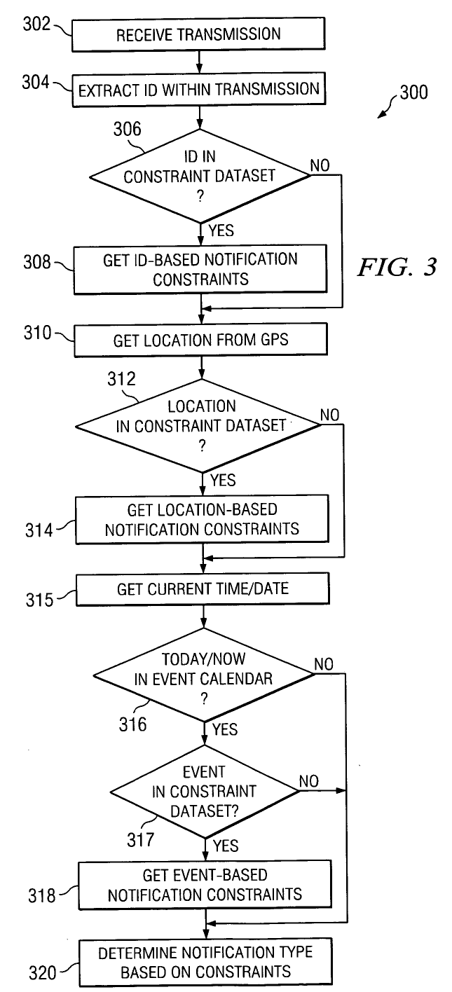

FIG. 3 illustrates a preferred method for processing a received transmission and determining the notification type, if any, to select and utilize to activate the notification device 150. Once a transmission is received as shown in block 302, and the originator ID is extracted as shown in block 304, the extracted originator ID may then be compared with entries in the ID dataset 112 as shown in block 306. If a match is found, the corresponding constraint is retrieved as shown in block 308. The originator ID information may be, for example, caller ID information for an incoming cellular telephone call, e-mail source information for an incoming e-mail, or an IM ID for an incoming instant message.

Current location information retrieved from GPS receiver 120, as shown in block 310, may then be compared with entries in the location constraints dataset 114 as shown in block 312. If the GPS coordinates of the current location match the coordinates of any of the entries within the locations constraints dataset 114, the corresponding constraint is retrieved as shown in block 314. The location data for an entry in the location constraints dataset 114 may be entered manually, or “learned” by the notification software 202. The user may manually enter the coordinates for a location via the user input device 180, or have the mobile electronic communication system 100 “learn” the location by storing the GPS coordinates of the current location.

Continuing on to block 315, the notification software 202 next retrieves the current time and date from the real-time clock 160, which is used to search the calendar of events dataset 111 to identify events that are in progress as shown in block 316. If an event is identified, the event constraints dataset 116 is searched, as shown in block 317, for constraints that match the identified event. Any matching constraints are retrieved as shown in block 318.

In accordance with at least some embodiments, the notification software 202 may also be adapted to match the current time and date with events in the calendar of events dataset 111 that are “near” the current time (e.g., where the current time is within five minutes of the start time or five minutes of the end time of the event entry). Thus, for example, if an executive is at one meeting where she generally doesn't want to be disturbed by incoming messages or calls on her cellular telephone, she may configure the cellular telephone to disable all notifications until five minutes before her next meeting, thus allowing people to reach her if there are any last minute changes that she needs to know about prior to the next meeting.

Upon completion of the constraint searches described, the notification software 202 combines the matched constraints thus located, determines whether or not to notify the user, and which notification type, if any, to select and utilize to activate the notification device 150, as shown in block 320. The notification type used may be selected from a list of notification types stored in the notification type dataset 118.

In accordance with at least some preferred embodiments, the application of the above-described constraints may be modified further by the notification software 202 based on the level and frequency distribution of the environmental noise. The audio I/O device 190 may be used to provide an audio sample of the environment around the mobile electronic communication system 100. This sample may allow the notification software 202 to determine the level of the background noise, as well as its frequency distribution. The level and frequency distribution can then be compared against pre-programmed threshold values to determine if an override of the notification type is necessary.

For example, if the sampled noise level of the surrounding environment is found by the notification software 202 to be so high that the current level of the selected ring tone will not be loud enough to be heard, the notification software 202 may increase the magnitude of the selected ring tone. Similarly, if the noise level is found by the notification software 202 to be so high that the maximum level of the selected ring tone will not be loud enough to be heard, the notification software 202 may switch the notification type to a vibration mode.

The frequency of a notification ring tone may also be overridden based on environmental noise characteristics. Thus, if the notification software 202 determines that the sampled noise contains frequency components near that of the ring tone (which may make the ring tone hard to hear), the notification software 202 may shift the frequency of the ring tone such that it is not masked by the noise. Such a shift may also be made in anticipation of specific types of noise, such as that encountered in an automobile (typically around 300 Hz) based on a known schedule event stored in the calendar of events 111 (e.g., a road trip to grandmother's house).

Additionally, the notification software 202 may increase the magnitude of the selected ring tone if a determination is made that the mobile electronic communication system 100 is in a confined area such as a pocket or a purse. The notification software 202 may make this determination by sampling the magnitude of the first ring and comparing it against the overall environmental noise. A large difference may indicate that the device is in an enclosed environment and may cause the notification software 202 to increase the magnitude of the selected ring tone.

The above disclosure is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic communication system, comprising:
a radio frequency (RF) receiver adapted to receive an RF transmission;
location logic adapted to determine a current location of the electronic communication system;
a central processing unit (CPU) coupled to the RF receiver and the location logic;
a notification device coupled to the CPU, the notification device adapted to signal a user that the RF transmission has been received; and
notification software adapted to execute on the CPU and to cause the CPU to determine whether to activate the notification device based on the current location of the electronic communication system.

2. The electronic communication system of claim 1,
wherein the notification software further causes the CPU to extract originator identification (ID) information from the RF transmission; and
wherein the determination by the CPU of whether to activate the notification device is further based on the ID information.

3. The electronic communication system of claim 1, further comprising:
a storage device coupled to the CPU, the storage device adapted to store a calendar of events; and
a real-time clock coupled to the CPU, the real-time clock adapted to provide the CPU with a current time and date;
wherein the determination by the CPU of whether to activate the notification device is further based on the calendar of events and on the current time and date.

4. The electronic communication system of claim 3,
wherein the notification software further causes the CPU to extract originator identification (ID) information from the RF transmission; and
wherein the determination by the CPU of whether to activate the notification device is further based on the ID information.

5. The electronic communication system of claim 1, further comprising:
an audio input device;
wherein the notification software causes the audio input device to generate audio samples of the environment around the electronic communication system; and
wherein the determination by the CPU of whether to activate the notification device is further based on characteristics of the generated audio samples.

6. The electronic communication system of claim 1, wherein the notification device is further adapted to generate a plurality of notification signals.

7. The electronic communication system of claim 6, wherein the plurality of notification signals comprises at least one of the group consisting of an audible tone sequence, a vibration sequence, and a visible indication sequence.

8. The electronic communication system of claim 1, wherein the location logic comprises a global positioning system receiver.

9. An electronic communication system, comprising:
a radio frequency (RF) receiver adapted to receive an RF transmission;
a central processing unit (CPU) coupled to the RF receiver;
a real-time clock coupled to the CPU, the real-time clock adapted to provide the CPU with a current time and date;
a storage device coupled to the CPU, the storage device adapted to store a calendar of events;
a notification device coupled to the CPU, the notification device adapted to signal a user that the RF transmission has been received; and
notification software adapted to execute on the CPU and to cause the CPU to determine whether to activate the notification device based on the calendar of events and on the current time and date.

10. The electronic communication system of claim 9,
wherein the notification software further causes the CPU to extract originator identification (ID) information from the RF transmission; and
wherein the determination by the CPU of whether to activate the notification device is further based on the ID information.

11. The electronic communication system of claim 9, further comprising:
location logic coupled to the CPU, the location logic adapted to determine a current location of the electronic communication system;
wherein the determination by the CPU of whether to activate the notification device is further based on the current location of the electronic communication system.

12. The electronic communication system of claim 11,
wherein the notification software further causes the CPU to extract originator identification (ID) information from the RF transmission; and
wherein the determination by the CPU of whether to activate the notification device is further based on the ID information.

13. The electronic communication system of claim 9, further comprising:
an audio input device;
wherein the notification software causes the audio input device to generate audio samples of the environment around the electronic communication system; and
wherein the determination by the CPU of whether to activate the notification device is further based on characteristics of the generated audio samples.

14. The electronic communication system of claim 11, wherein the location logic comprises a global positioning system receiver.

15. The electronic communication system of claim 9, wherein the notification device is adapted to generate a plurality of notification signals.

16. The electronic communication system of claim 15, wherein the plurality of notification signals comprises at least one of the group consisting of an audible tone sequence, a vibration sequence, and a visible indication sequence.

17. A method for use in an electronic communication system comprising a notification device, comprising:
receiving a transmission;
determining a current location of the electronic communication system;
matching the current location with an entry in a list of location-based constraints; and
determining whether to activate the notification device indicating that the transmission has been received, the determination limited by a location-based constraint matched to the current location.

18. The method of claim 17, further comprising:
extracting originator identification (ID) information from the transmission;
matching the ID information with an entry in a list of ID-based constraints; and
limiting further the determination of whether to activate the notification device, the limitation further based on an ID-based constraint matched to the extracted ID information.

19. The method of claim 17, further comprising:
determining a current time and date;
matching the current time and date with an event stored in a list of events;
matching the event with an entry in a list of event-based constraints; and
limiting further the determination of whether to activate the notification device, the limitation further based on an event-based constraint matched to the event.

20. The method of claim 19, further comprising:
extracting originator identification (ID) information from the received transmission;
matching the ID information with entries in a list of ID-based constraints; and
limiting further the determination of whether to activate the notification device, the limitation further based on an ID-based constraint matched to the extracted ID information.

21. The method of claim 17, further comprising:
generating audio samples of the environment around the electronic communication system; and
limiting further the determination of whether to activate the notification device, the limitation further based on characteristics of the generated audio samples.

22. The method of claim 17, further comprising:
selecting one of a plurality of notification signals producible by the activation device; and
using the selected signal to advise the user that the transmission has been received.

23. A method, usable in a electronic communication system comprising a notification device, comprising:
receiving a transmission;
determining a current time and date;
matching the current time and date with an entry in a list of event-based constraints; and
determining whether to activate the notification device indicating that a transmission has been received, the determination limited by an event-based constraint matched to the current time and date.

24. The method of claim 23, further comprising:
extracting originator identification (ID) information from the received transmission;
matching the ID information with entries in a list of ID-based constraints; and
limiting further the determination of whether to activate the notification device, the limitation further based on an ID-based constraint matched to the extracted ID information.

25. The method of claim 23, further comprising:
determining a current location of the electronic communication system;
matching the current location with an entry in a list of location-based constraints; and
limiting further the determination of whether to activate the notification device, the limitation further based on a location-based constraint matched to the current location.

26. The method of claim 25, further comprising:
extracting originator identification (ID) information from the received transmission;
matching the ID information with entries in a list of ID-based constraints; and
limiting further the determination of whether to activate the notification device, the limitation further based on an ID-based constraint matched to the extracted ID information.

27. The method of claim 23, further comprising:
generating audio samples of the environment around the electronic communication system; and
limiting further the determination of whether to activate the notification device, the limitation further based on characteristics of the generated audio samples.

28. The method of claim 23, further comprising:
selecting one of a plurality of notification signals producible by the activation device; and
using the selected signal to advise the user that the transmission has been received.
